(19) United States
(12) Patent Application Publication
(10) Pub. No.: US 2024/0019263 A1
(43) Pub. Date: Jan. 18, 2024

(54) INFORMATION PROCESSING APPARATUS, INFORMATION PROCESSING METHOD, AND MOVING OBJECT

(71) Applicant: TOYOTA JIDOSHA KABUSHIKI KAISHA, Toyota-shi (JP)

(72) Inventors: Yoshikazu JIKUHARA, Miyoshi-shi (JP); Yoshinori KANEMITSU, Tachikawa-shi (JP); Yurika TANAKA, Yokosuka-shi (JP); Keiichi UNO, Chita-gun (JP)

(73) Assignee: TOYOTA JIDOSHA KABUSHIKI KAISHA, Toyota-shi (JP)

(21) Appl. No.: 18/325,372

(22) Filed: May 30, 2023

(30) Foreign Application Priority Data
Jul. 12, 2022 (JP) 2022-111811

(51) Int. Cl. G01C 21/36; G01C 21/34

(52) U.S. Cl. CPC G01C 21/3661; G01C 21/3438; G01C 21/3629; G01C 21/3641

(57) ABSTRACT

An information processing apparatus includes a controller configured to dispatch a guidance device to a gathering point for a disabled person who has made a reservation for the use of a bus, to generate a command to move the dispatched guidance device from the gathering point to a point set as a bus stop for the bus, and to transmit the command thus generated to the guidance device.

### CROSS REFERENCE TO THE RELATED APPLICATION

This application claims the benefit of Japanese Patent Application No. 2022-111811, filed on Jul. 12, 2022, which is hereby incorporated by reference herein in its entirety.

### BACKGROUND

### Technical Field

The present disclosure relates to an information processing apparatus, an information processing method, and a moving object.

### Description of the Related Art

There has been known a technique in which the location of a vehicle to be dispatched on demand and the distance thereof to a boarding place are distributed to a user terminal (see, for example, Patent Literature 1).

### CITATION LIST

### Patent Literature

Patent Literature 1: Japanese Patent Application Laid-Open Publication No. 2020-098650

### SUMMARY

It may be difficult for a disabled person with impaired vision or impaired legs to move to a place set as a bus stop for an on-demand type bus, depending on a route heading to the bus stop. The present disclosure is to more safely guide a disabled person to a place or location set as a bus stop.

One aspect of the present disclosure is directed to an information processing apparatus comprising a controller configured to dispatch a guidance device to a gathering point for a disabled person who has made a reservation for the use of a bus, to generate a command to move the dispatched guidance device from the gathering point to a point set as a bus stop for the bus, and to transmit the command thus generated to the guidance device.

Another aspect of the present disclosure is directed to an information processing method comprising: dispatching, by a computer, a guidance device to a gathering point for a disabled person who has made a reservation for the use of a bus; generating a command to move the dispatched guidance device from the gathering point to a point set as a bus stop for the bus; and transmitting the command thus generated to the guidance device.

A further aspect of the present disclosure is directed to a moving object which is to be dispatched to a gathering point for a disabled person who has made a reservation for use of a bus, the moving object being configured to move from the gathering point to a point set as a bus stop for the bus via a route corresponding to the type of disability of the disabled person.

According to the present disclosure, it is possible to more safely guide a disabled person to a bus stop for a bus.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of a guidance device, a user terminal, a server, and a bus, which together constitute the system according to the embodiment;

FIG. 3 is a diagram illustrating an example of a functional configuration of the server;

FIG. 4 is a view illustrating an example of a table structure of a user information DB;

FIG. 5 is a view illustrating an example of a table structure of a bus information DB;

FIG. 6 is a view illustrating an example of a table structure of a disability support information DB;

FIG. 7 is a view illustrating an example of a table structure of a guidance device information DB;

FIG. 8 is a diagram illustrating a functional configuration of the guidance device;

FIG. 9 is a view illustrating an example of a screen for notifying that the guidance device according to the embodiment has arrived;

FIG. 10 is a diagram illustrating a functional configuration of the user terminal;

FIG. 11 is a flowchart of processing of generating operation commands for the guidance device and the bus in the server;

FIG. 12 is a flowchart of processing at the time of the operation of the guidance device according to the present embodiment; and

FIG. 13 is a flowchart of the processing executed in step S207 of FIG. 12.

### DESCRIPTION OF THE EMBODIMENTS

An information processing apparatus according to one aspect of the present disclosure includes a controller. The controller is configured to dispatch a guidance device to a gathering point for a disabled person who has made a reservation for the use of a bus, to generate a command to move the dispatched guidance device from the gathering point to a point set as a bus stop for the bus, and to transmit the command thus generated to the guidance device.

The point set as the bus stop for the bus (hereinafter, also simply referred to as a bus stop) includes a point set in advance as a bus stop, a point desired by a user, a point which is near the point desired by the user and at which the bus can stop, or the like. Here, note that the point set as the bus stop in advance include a point that is used as a bus stop only when there is a reservation in advance.

In addition, the gathering point for the disabled person is, for example, a point or location at which the disabled person can safely arrive without being guided by others or the like. The controller may identify such a gathering point based, for example, on location information obtained from a mobile terminal carried by the disabled person at the gathering point. The guidance device is, for example, a moving object or vehicle that autonomously travels or autonomously flies. The guidance device may move according to operation commands received from the controller, for example.

Here, in the case of a demand-type bus, there may be no permanent sign at the bus stop, so that the disabled person using the bus may not notice at a glance that the point is the bus stop. Therefore, there is a concern that the disabled person using the bus may not know where to go. In addition, in cases where the disabled person is a bus user, it is also conceivable that there may be a point or location on a route toward the bus stop where the disabled person is difficult to move, depending on the type of his or her disability. Therefore, it is conceivable to dispatch the guidance device to the gathering point for the disabled person and have the guidance device thus dispatched guide the user to the bus stop. By using such a guidance device, it is possible to guide disabled persons collected in the gathering point to the bus stop. Therefore, it is possible to more safely guide the disabled persons to the bus stop.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

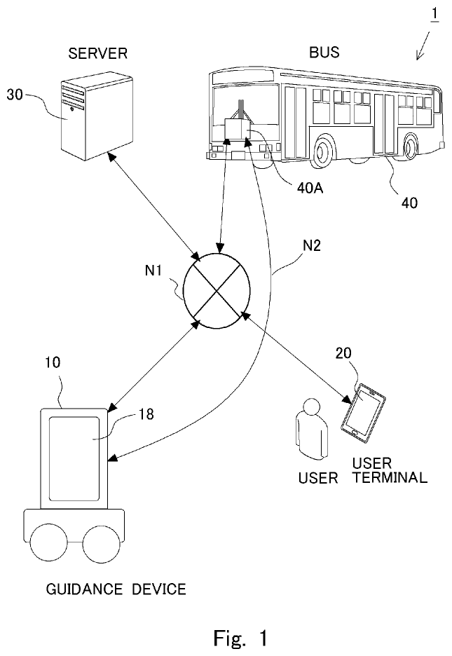

FIG. 1 is a view illustrating a schematic configuration of a system 1 according to an embodiment. The system 1 is a system in which, when a server 30 receives a use request for a bus 40 from a user with a disability (disabled person) from a user terminal 20, the server 30 generates a route for the bus 40 so as to allow the user to use the bus 40, and dispatches a guidance device 10 to a gathering point for users. Then, in this system 1, the guidance device 10 guides the user from the gathering point for users to a stop point for the bus 40. Here, note that in the following, the stop point of the bus 40 is assumed to indicate a boarding point where the user gets on the bus 40 or an alighting point where the user gets off the bus 40.

The user can reserve the bus 40 by transmitting a use request to the server 30 via the user terminal 20. The use request is information for the user to use the bus 40. The use request includes a boarding point where the user gets on the bus 40, a gathering point where the user gathers before moving to the boarding point, a boarding date and time when the user gets on the bus 40, an alighting point where the user gets off the bus 40, and disability information about the disability that the user has. The user can transmit the use request to the server 30 by executing a predetermined application installed on the user terminal 20, for example.

The bus 40 is a vehicle in demand-type transportation operated according to user's reservations. The bus 40 is, for example, a vehicle that is driven by a driver, but as an alternative, it may be a vehicle capable of autonomous driving. The bus 40 travels in a route including the boarding point and the alighting point of the user. This route may vary depending on the boarding points and alighting points of other users. In addition, the locations of bus stops may also have been determined in advance. Then, the bus stops to be passed through may be selected according to the reservations. In addition, the location of each bus stop may be optionally determined. The locations of the bus stops and the route of the bus 40 may be determined, for example, by the server 30. Here, note that the bus 40 is not limited to a large vehicle, but may be a small passenger vehicle or the like.

The guidance device 10 has, for example, a configuration of an electric vehicle, and runs by operating a motor with electric power stored in a battery. In addition, the guidance device 10 is capable of autonomous driving. The guidance device 10 has, for example, a display 18. By displaying information such as a text or the like to guide the user on the display 18, it is possible to tell the user a route to the bus stop and alert the user to obstacles such as steps on a sidewalk. The server 30 generates commands for moving the guidance device 10 based on the stop point and the stop time of the bus 40. The server 30 manages the operation of the guidance device 10 so that the guidance device 10 arrives at the gathering point for users, for example, taking into account a moving or traveling time from the gathering point to the bus stop. The server 30 manages the operation of the guidance device 10 so that the guidance device 10 arrives at the gathering point earlier by, for example, a time obtained by adding a predetermined time to the moving time from the gathering point to the bus stop.

The server 30 is a device that manages the guidance device 10 and the bus 40. Upon receiving a request for the use of the bus 40 from the user terminal 20, the server 30 determines the guidance device 10 to be dispatched to the user's gathering point and the bus 40 to be used by the user, generates operation commands for the guidance device 10 and the bus 40, and transmits the operation commands to the guidance device 10 and the bus 40.

The guidance device 10, the user terminal 20, the server 30, and the bus 40 are mutually connected to one another by means of a network N1. The network N1 is, for example, a worldwide public communication network such as the Internet or the like, and a WAN (Wide Area Network) or other communication networks may be adopted. Also, the network N1 may include a telephone communication network such as a mobile phone network or the like, or a wireless communication network such as Wi-Fi (registered trademark) or the like. In addition, the guidance device 10 is connected to the bus 40, for example, through a network N2. The network N2 performs data communication using, for example, V2V (Vehicle to Vehicle) communication, Bluetooth (registered trademark) Low Energy, NFC (Near Field Communication), UWB (Ultra Wideband), Wi-Fi (registered trademark), or the like.

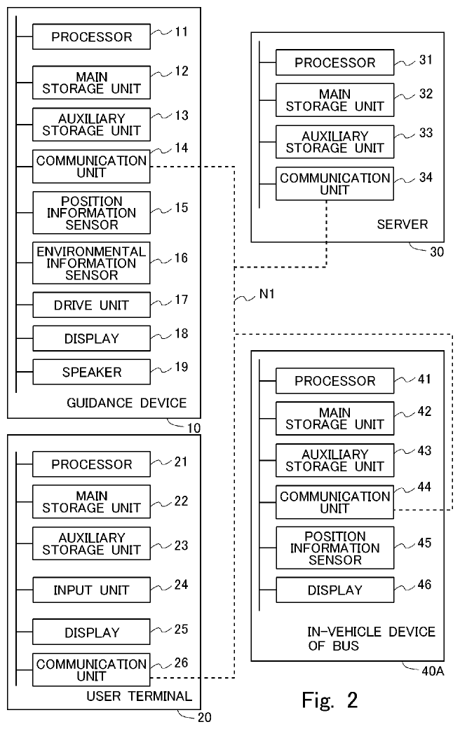

The hardware configurations of the guidance device 10, the user terminal 20, the server 30, and an in-vehicle device 40A of the bus 40 will be described based on FIG. 2. FIG. 2 is a block diagram schematically illustrating an example of a configuration of each of the guidance device 10, the user terminal 20, the server 30, and the bus 40, which together constitute the system 1 according to the present embodiment.

The server 30 has a configuration of a computer. The server 30 includes a processor 31, a main storage unit 32, an auxiliary storage unit 33, and a communication unit 34. These components are connected to one another by means of a bus. The processor 31 is an example of a controller.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the guidance device 10, the user terminal 20, and the bus 40 via the network N1. The communication unit 34 is, for example, a LAN (Local Area Network) interface board, a wireless communication circuit for wireless communication, or the like. The LAN interface board or the wireless communication circuit is connected to the network N1.

Next, the guidance device 10 is, for example, a moving object or vehicle that is capable of autonomously traveling, and has a configuration of a computer. The guidance device 10 includes a processor 11, a main storage unit 12, an auxiliary storage unit 13, a communication unit 14, a position information sensor 15, an environmental information sensor 16, a drive unit 17, a display 18, and a speaker 19. These components are mutually connected to one another by means of a bus. The processor 11, the main storage unit 12, and the auxiliary storage unit 13 are the same as the processor 31, the main storage unit 32, and the auxiliary storage unit 33 of the server 30, respectively, and hence, the description thereof will be omitted.

The communication unit 14 is a communication means or unit for connecting the guidance device 10 to the network N1 or the network N2. The communication unit 14 is a circuit for communicating with another device (e.g., the server 30, the bus 40 or the like) via the network N1 or the network N2 by making use of a mobile communication service (e.g., a telephone communication network such as 5G (5th Generation), 4G (4th Generation), 3G (3rd Generation), LTE (Long Term Evolution) or the like), and/or a wireless communication network such as V2V (Vehicle to Vehicle) communication network, Wi-Fi (registered trademark), Bluetooth (registered trademark) Low Energy, NFC (Near Field Communication), UWB (Ultra Wideband) or the like.

The position information sensor 15 obtains position information (e.g., latitude and longitude) of the guidance device 10 at a predetermined cycle. The position information sensor 15 is, for example, a GPS (Global Positioning System) receiver unit, a wireless communication unit or the like. The information obtained by the position information sensor 15 is recorded, for example, in the auxiliary storage unit 13 or the like and transmitted to the server 30.

The environmental information sensor 16 is a means or unit for sensing the state of the guidance device 10 or sensing an area around the guidance device 10. As a sensor for sensing the state of the guidance device 10, there is mentioned a gyro sensor, an acceleration sensor, an azimuth sensor, or the like. Also, as a sensor for sensing the area around the guidance device 10, there is mentioned a stereo camera, a laser scanner, a LIDAR, a radar, or the like.

The drive unit 17 is a device for driving the guidance device 10 based on control commands generated by the processor 11. The drive unit 17 is configured to include, for example, a plurality of motors or the like for driving wheels provided on the guidance device 10, so that the plurality of motors or the like are driven according to the control commands to realize autonomous driving of the guidance device 10.

The display 18 includes a means or unit that presents information to the user, and is, for example, an LCD (Liquid Crystal Display), an EL (Electroluminescence) panel, or the like. In addition, the speaker 19 is a means or unit that outputs voice, a warning sound or the like.

Now, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, and a communication unit 26. These components are mutually connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted.

The input unit 24 is a means or unit that receives an input operation performed by the user, and is, for example, a touch panel, a mouse, a keyboard, a push button, or the like. The display 25 is a means or unit that presents information to the user, and is, for example, an LCD (Liquid Crystal Display), an EL (Electroluminescence) panel, or the like. The input unit 24 and the display 25 may be configured as a single touch panel display.

The communication unit 26 is a communication means or unit for connecting to the network N1, and is a circuit for communicating with another device (e.g., the server 30 or the like) via the network N1 by making use of a mobile communication service (e.g., a telephone communication network such as 5G (5th Generation), 4G (4th Generation), 3G (3rd Generation), LTE (Long Term Evolution) or the like), and/or a wireless communication network such as Wi-Fi (registered trademark), Bluetooth (registered trademark) Low Energy, NFC (Near Field Communication), UWB (Ultra Wideband) or the like.

Next, the bus 40 is provided with the in-vehicle device 40A. The in-vehicle device 40A has a configuration of a computer. The in-vehicle device 40A of the bus 40 includes a processor 41, a main storage unit 42, an auxiliary storage unit 43, a communication unit 44, a position information sensor 45, and a display 46. These components are mutually connected to one another by means of a bus. The processor 41, the main storage unit 42, and the auxiliary storage unit 43 are the same as the processor 31, the main storage unit 32, and the auxiliary storage unit 33 of the server 30, respectively, and hence, the description thereof will be omitted. In addition, the communication unit 44 and the position information sensor 45 are the same as the communication unit 14 and the position information sensor 15 of the guidance device 10, respectively, and hence, the description thereof will be omitted. Also, the display 46 is the same as the display 25 of the user terminal 20, so the description thereof is omitted. Here, note that the bus 40 may be, for example, a moving object that can autonomously travel. In this case, as in the case of the guidance device 10, the processor 41 controls the bus 40 based on commands or instructions from the server 30.

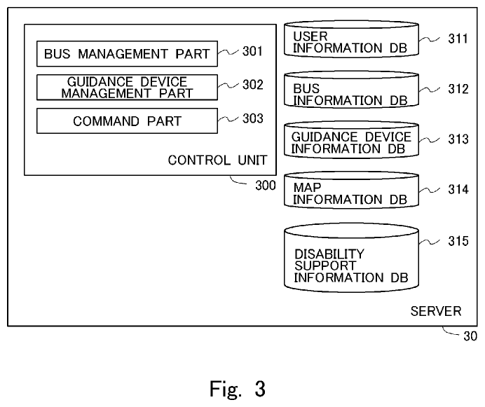

Then, the functions of the server 30 will be described. FIG. 3 is a diagram illustrating an example of a functional configuration of the server 30. The server 30 includes, as its functional components, a control unit 300, a user information DB 311, a bus information DB 312, a guidance device information DB 313, a map information DB 314, and a disability support information DB 315. The processor 31 of the server 30 executes the processing of the control unit 300 by means of a computer program on the main storage unit 32. However, any of the individual functional components or a part of the processing thereof may be implemented by a hardware circuit. The control unit 300 includes a bus management part 301, a guidance device management part 302, and a command part 303.

The user information DB 311, the bus information DB 312, the guidance device information DB 313, the map information DB 314 and the disability support information DB 315 are built by a program of a database management system (DBMS) that is executed by the processor 31 to manage data stored in the auxiliary storage unit 33. The user information DB 311, the bus information DB 312, the guidance device information DB 313, the map information DB 314 and the disability support information DB 315 are, for example, relational databases.

Here, note that any of the individual functional components of the server 30 or a part of the processing thereof may be executed by another computer or other computers connected to the network N1.

The bus management part 301 collects information about buses 40 and updates the bus information DB 312, which will be described later. To be specific, the bus management part 301 periodically communicates with a plurality of buses 40 and collects information about the current locations of the buses 40. The information thus collected is reflected in the bus information DB 312 described later.

In addition, the bus management part 301 obtains a use request from a user who wants to use a bus 40. The use request is information transmitted from a user terminal 20 to the server 30. The use request includes user ID, boarding point, gathering point, boarding date and time, alighting point, and disability information. The use request may further include information about the number of persons who use the bus 40. The user ID is an identifier unique to the user. The user information (e.g., name, address, telephone number, e-mail address, etc.) corresponding to the user ID may be registered in advance by the user using the user terminal 20, or may be transmitted from the user terminal 20 together with the use request. This user information is stored in the auxiliary storage unit 33 in association with the user ID. In addition, the boarding point, gathering point, boarding date and time, alighting point, and disability information included in the use request are stored in the user information DB 311.

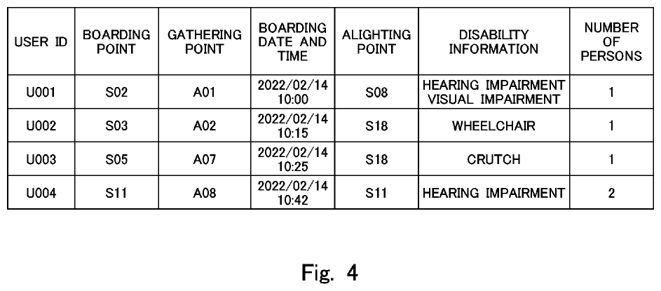

Here, FIG. 4 illustrates an example of a table structure of the user information DB 311. The user information DB 311 has fields for user ID, boarding point, gathering point, boarding date and time, alighting point, disability information, and number of persons. In the user ID field, information that can identify each user (user ID) is entered. The boarding point field stores information about a boarding point included in each use request. The boarding point is a point at which each user wants to board the bus 40, and is indicated, for example, by coordinates (latitude and longitude), an address, the name of a building, or the name or number of a bus stop. A gathering point is a point or location at which each user gathers before moving to a bus stop, and is indicated, for example, by coordinates (latitude and longitude), an address, the name of a building, or the like.

The boarding date and time field stores information about a boarding date and time included in each use request. The boarding date and time is a date and time when each user wants to board the bus 40. Note that the boarding date and time may be designated as a time zone with a certain width. The alighting point field stores information about an alighting point included in each use request. The alighting point is a point at which the user wants to get off the bus 40, and is indicated, for example, by coordinates (latitude and longitude), an address, the name of a building, or the name or number of a bus stop. Here, note that the boarding point or the alighting point may be a point or location that has been registered in advance in the auxiliary storage unit 33 of the server 30 as a point or location where the bus 40 can stop. The disability information field stores information indicating a disability that each user has. In cases where a plurality of users have different disabilities, information indicating the plurality of disabilities may be listed in the disability information field. The information indicating disability may be information indicating a disability that the user has (e.g., visual impairment, hearing impairment, wheelchair, crutch, etc.), or may be information indicating a transportation means or a transportation assistance means of the user with a disability (e.g., “wheelchair”, “crutch”, etc.). The number of persons field stores information about the number of persons included in each use request. This number of persons is the number of persons who want to board the bus 40.

Upon receiving a use request from a user terminal 20, the command part 303 selects a bus 40 that can be dispatched (hereinafter, also referred to as a dispatchable bus) based on information such as the boarding point, boarding date and time, alighting point, and type of disability included in the use request. The dispatchable bus 40 is a bus 40 that has seats available for the number of persons, is available to move to the boarding point on the boarding date and time, and is available to move to the alighting point after that. For example, a bus 40 that has a reservation for boarding or alighting at another point on the same date and time does not correspond to a bus 40 that can be moved to the boarding point on the boarding date and time. Therefore, the dispatchable bus 40 may be selected according to the current route of the bus 40.

Once the dispatchable bus 40 is selected, the command part 303 generates an operation command, which is a command for operating the bus 40. The operation command includes, for example, a route of the bus 40. The command part 303 generates the route based on the map information stored in the map information DB 314. For example, the command part 303 generates the operation command so that the bus 40 departs from the current location and travels through each dispatch point on each dispatch date and time.

Note that the map information DB 314 stores, as map information, for example, link data about roadways or sidewalks (links), node data about node points, intersection data about each intersection, search data for searching routes, facility data about facilities, search data for searching points, etc. In addition, information about the points where buses 40 can stop may also be stored.

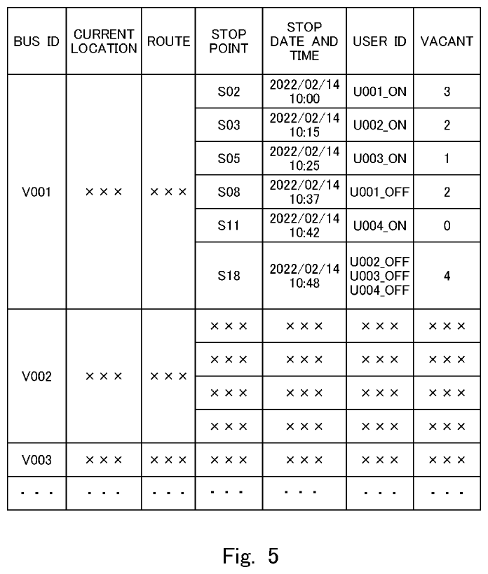

The command part 303 updates the bus information DB 312 upon generating the operation command for the bus 40. Here, a structure or configuration of the bus information stored in the bus information DB 312 will be described based on FIG. 5. FIG. 5 is a view illustrating an example of a table structure of the bus information DB 312. A bus information table has fields for bus ID, current location, route, stop point, stop date and time, user ID, and vacant (available) seat. In the bus ID field, information that can identify each bus 40 (bus ID) is entered. A bus ID is assigned to each bus 40, for example, by the bus management part 301. In the current location field, information about the current position or location of each bus 40 (position information) is entered. The current location of each bus 40 is detected by the position information sensor 45 of the bus 40, and transmitted to the server 30. The current location field is updated each time position information is received from each bus 40.

In the route field, information about the route of each bus 40 is entered. In the stop point field, information about a point where each bus 40 stops is entered. In the stop point field, information about a point that can be the destination of each bus 40, such as coordinates, an address, the name of a building or the like, is entered. The point at which each bus 40 stops is a point at which a user gets on or off, and is entered based on information about a boarding point or an alighting point included in a use request of any user. Here, note that the stop points for each bus in their column are arranged in the order in which the bus 40 stops. In the stop date and time field, information about the stop date and time of each bus 40 corresponding to each stop point is entered. Here, note that the date and time when a user arrives at an alighting point may be calculated based on the boarding time and the time required for a bus 40 to move from the boarding point to the alighting point. The time required for the movement or travel of the bus 40 can be calculated from past data, a traveling or moving distance or the like, the date and time of arrival at the alighting point may be calculated based on this time.

In the user ID field, an identification code (user ID) unique to each user is entered. Also, a character string corresponding to boarding or alighting is added after each user ID. When a user gets on at a corresponding stop point, a character string “ON” is added after his or her user ID, and when a user gets off at a corresponding stop point, a character string “OFF” is added after his or her user ID. The vacant seat field stores the number of vacant (available) seats on the bus 40 at the time of departing from a corresponding stop point.

In addition, after selecting a bus 40 that corresponds to a boarding point and an alighting point for each user, the command part 303 further selects a guidance device 10 to guide each user to the corresponding boarding point of the bus 40. Once the guidance device 10 is selected, the command part 303 generates an operation command, which is a command for operating the guidance device 10. The operation command for the guidance device 10 includes, for example, a route for the guidance device 10. The command part 303 generates the route for the guidance device 10 based on the map information stored in the map information DB 314 and the difficult-to-move point information stored in the disability support information DB 315. For example, the command part 303 generates the operation command so as to cause the guidance device 10 to depart from the current location, head to the gathering point for users, and travel from the gathering point to the bus stop via the route along which the user is able to move according to the disability of the user. The guidance device 10, for example, travels on sidewalks to guide the user from the gathering point to the bus stop.

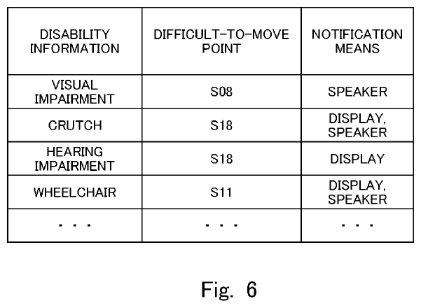

Here, note that the disability support information DB 315 stores, as the difficult-to-move point information, for example, difficult-to-move point data, which indicates points where movement of each user is difficult according to the type of user's disability, notification means, etc. Here, a configuration of the disability support information stored in the disability support information DB 315 will be described based on FIG. 6. FIG. 6 is a view illustrating an example of a table structure of the disability support information DB 315. A disability support information table has fields for disability information, difficult-to-move points, and notification means. The disability information field stores information (e.g., visual impairment, hearing impairment, wheelchair, crutch, etc.) indicating disabilities that hinder the movement of each user. The difficult-to-move point field stores information indicating difficult-to-move points for users with disabilities indicated by the information stored in the disability information field. The notification means field stores notification means that are preferable (i.e., able to notify) to the users having the disabilities indicated by the information stored in the disability information field. The command part 303 obtains the disability information included in each use request. Then, the command part 303 obtains from the disability support information DB 315 difficult-to-move points associated with the disability information thus obtained. The command part 303 determines, based on the map information DB 314, a route from the current location to a gathering point for users and from the gathering point to the bus stop by avoiding the difficult-to-move points thus obtained.

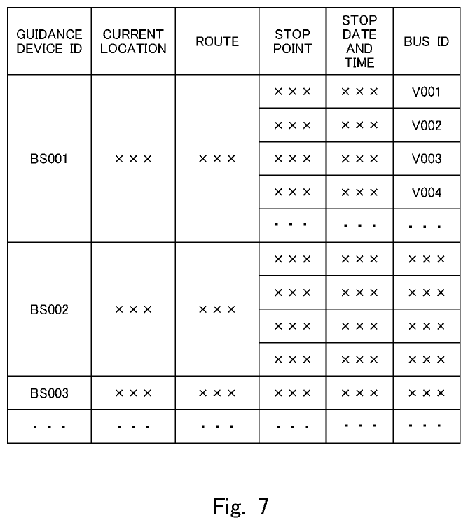

The command part 303 updates the guidance device information DB 313 when generating the operation command for the guidance device 10. Here, a configuration of the guidance device information stored in the guidance device information DB 313 will be described based on FIG. 7. FIG. 7 is a view illustrating an example of a table structure of the guidance device information DB 313. A guidance device information table has fields for guidance device ID, current location, route, stop point, stop date and time, and bus ID. In the guidance device ID field, information that can identify each guidance device 10 (guidance device ID) is entered. A guidance device ID is assigned to each guidance device 10, for example, by the guidance device management part 302. In the current location field, information about the current position or location of each guidance device 10 (position information) is entered. The current location of each guidance device 10 is detected by the position information sensor 15 of the guidance device 10 at predetermined time intervals, and is transmitted to the server 30.

In the route field, information about the route of each guidance device 10 is entered. In the stop point field, information about points at which each guidance device 10 stops is entered. In the stop point field, information about a point that can be the destination of each guidance device 10, such as coordinates, an address, the name of a building or the like, is entered. The points where each guidance device 10 stops are, for example, gathering points of users and bus stops. Here, note that the stop points for each guidance device 10 in their column are arranged in the order in which the guidance device 10 stops. In the stop date and time field, information about the stop date and time of each guidance device 10 corresponding to each stop point is entered. Here, note that information about the date and time of departure from each bus stop may also be entered. In the bus ID field, a bus ID corresponding to each stop point is entered.

In addition, when a guidance device 10 arrives at a gathering point for users, the command part 303 generates a command so as to notify the surroundings of the arrival of the guidance device 10 at the gathering point for users, and transmits the command to the guidance device 10. The command part 303 generates, for example, a command to cause the display 18 of the guidance device 10 to output information indicating that the guidance device 10 is a guidance device to guide users to the bus stop. As the information indicating that the guidance device 10 is a guidance device to guide users to the bus stop, the display 18 shows, for example, information indicating the bus stop to which the users are being guided and the time at which the bus 40 will arrive at the bus stop. The command part 303 generates the command so as to continuously notify the users at their gathering point until the time when the guidance device 10 will leave for the bus stop.

Moreover, instead of, or in addition to, displaying a screen on the display 18 to notify that the guidance device 10 has arrived, the command part 303 may also cause the speaker 19 to output a voice indicating the fact that the guidance device 10 has arrived, as well as the time at which the guidance device 10 will leave for the bus stop. For example, a command may be generated to output a voice such as “This guidance device will leave for the bus stop at 10 o'clock” or “This guidance device will leave for the bus stop in 5 minutes” from the speaker 19.

Further, the command part 303 may generate a command to cause the guidance device 10 to notify the arrival of the guidance device 10 and the time when the guidance device 10 will leave for the bus stop, by using the notification means associated with the user's disability information obtained from the use request based on the disability support information DB 315.

Furthermore, the command part 303 may also cause the guidance device 10 to notify the users of the difficult-to-move points that exist on the route from the gathering point to the bus stop based on the disability support information DB 315. At this time, the command part 303 may generate a command to notify a difficult-to-move point which is in the direction of movement of the guidance device 10 heading for the bus stop and to which the guidance device 10 is approaching within a predetermined distance.

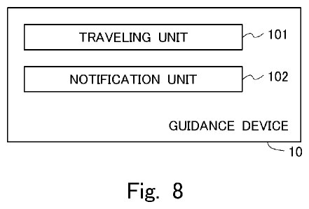

Next, the functions of the guidance device 10 will be described. FIG. 8 is a diagram illustrating a functional configuration of the guidance device 10. The guidance device 10 includes, as its functional components, a traveling unit 101 and a notification unit 102. The processor 11 of the guidance device 10 executes the processing of the traveling unit 101 and the notification unit 102 by a computer program on the main storage unit 12. However, any of the individual functional components or a part of the processing thereof may be implemented by a hardware circuit. Here, note that any of the individual functional components of the guidance device 10 or a part of the processing thereof may be executed by another or other computers connected to the network N1.

The traveling unit 101 controls traveling of the guidance device 10 during autonomous traveling thereof. The traveling unit 101 generates control commands for controlling the drive unit 17 by using the data detected by the environmental information sensor 16. The traveling unit 101 controls, for example, the rotational speeds of a plurality of motors to control the speed of the guidance device 10, or control the steering angle thereof.

For example, the traveling unit 101 generates a travel trajectory of the guidance device 10 based on the data detected by the environmental information sensor 16, and controls the drive unit 17 so that the guidance device 10 travels along the travel trajectory. Here, note that as a method of causing the guidance device 10 to travel in an autonomous manner, there can be adopted a known method. The traveling unit 101 may perform feedback control based on the detection value of the environmental information sensor 16 during autonomous traveling. The traveling unit 101 controls the drive unit 17 so that the guidance device 10 autonomously travels around a predetermined route. This route is included in the operation command transmitted from the server 30. For example, the traveling unit 101 causes the guidance device 10 to travel based on the travel route and the stop positions included in the operation command received from the server 30. The operation command received from the server 30 is stored in the auxiliary storage unit 13 by the traveling unit 101, for example.

In addition, the traveling unit 101 periodically transmits information about the guidance device 10 to the server 30. The traveling unit 101 transmits, for example, information about the current location obtained by the position information sensor 15 and the remaining capacity of the battery to the server 30 as information about the guidance device 10.

Then, at the gathering point for users, the notification unit 102 executes notification processing, which is the processing of notifying the fact that the guidance device 10 has arrived and the time when the guidance device 10 will leave for the bus stop. The notification unit 102 executes the notification processing when a condition on the position of the guidance device 10 is satisfied. The notification unit 102 compares the position information detected by the position information sensor 15 with the stop point included in the operation command transmitted from the server 30, and determines that the condition on the position is satisfied, in cases where the current location of the guidance device 10 is within a predetermined area from the gathering point for users.

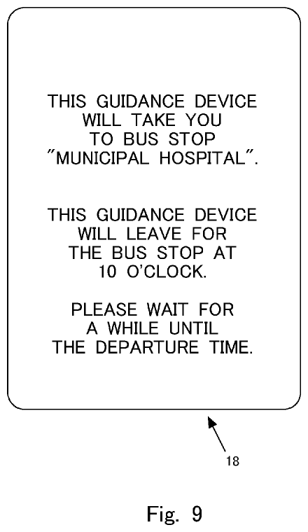

When determining that the position condition is satisfied, the notification unit 102 displays, for example, a screen illustrated in FIG. 9 on the display 18. FIG. 9 is a view illustrating an example of a screen for notifying that the guidance device 10 according to the embodiment has arrived. The display 18 shows information indicating that the guidance device 10 is a guidance device to guide users to the bus stop where the bus 40 will stop, and information indicating a departure time for the guidance device 10 to leave for the bus stop. In FIG. 9, “This guidance device will guide you to the bus stop Municipal Hospital.” is displayed to notify that the guidance device 10 is a guidance device to guide users to the bus stop Municipal Hospital. In addition, “Departure for the bus stop at 10:00 a.m.” is also displayed to notify the users that the departure time to leave for the bus stop is 10:00. The screen illustrated in FIG. 9 starts to be displayed when the guidance device 10 arrives at the gathering point. Then, the guidance device 10 continues to display the screen illustrated in FIG. 9 on the display 18 until the guidance device 10 departs.

Instead of, or in addition to, displaying the screen illustrated in FIG. 9 on the display 18, the command part 303 may also notify, by voice from the speaker 19, information indicating that the guidance device 10 is a guidance device to guide users to the bus stop where the bus 40 will stop, and information indicating the time of departure for the bus stop. For example, a voice such as “This guidance device will leave for the bus stop at 10 o'clock” or “This guidance device will leave for the bus stop in 5 minutes” may be output from the speaker 19.

The guidance device 10 may move or travel toward the bus stop while the notification unit 102 is notifying the users of difficult-to-move points that exist in the direction of travel. The notification unit 102 may notify the users of difficult-to-move points where obstacles such as, for example, stairs, level differences (steps), poles installed on the road, etc., exist in the direction of travel. Then, when the guidance device 10 arrives at the bus stop, the notification unit 102 may notify the fact that the guidance device 10 has arrived at the bus stop.

Then, upon arrival at the bus stop, the traveling unit 101 causes the guidance device 10 to move toward the next destination.

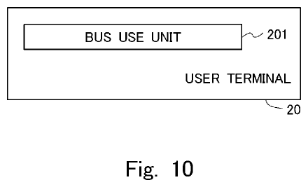

Now, the functions of the user terminal 20 will be described. FIG. 10 is a diagram illustrating a functional configuration of the user terminal 20. The user terminal 20 has a bus use unit 201 as its functional component. The processor 21 of the user terminal 20 executes the processing of the bus use unit 201 by a computer program on the main storage unit 22. However, a part of the processing of the bus use unit 201 may be executed by a hardware circuit. Note that a part of the processing of the bus use unit 201 may be executed by another or other computers connected to the network N1.

The bus use unit 201 has a function of accessing and interacting with the server 30. This function may be implemented by a web browser operating on the user terminal 20 or by dedicated application software. Here, note that in the embodiment, the bus use unit 201 is configured to be able to execute application software for interacting with the server 30. The bus use unit 201 generates a use request according to input to the input unit 24 of the user terminal 20.

For example, the bus use unit 201 may ask a user to input a boarding point desired by the user (hereinafter also referred to as a desired boarding point), a gathering point desired by the user (hereinafter also referred to as a desired gathering point), a boarding date and time desired by the user (hereinafter referred to as a desired boarding date and time), an alighting point desired by the user (hereinafter also referred to as a desired alighting point), the number of persons, and disability information regarding the disabilities of the persons (users). In this case, the current location of the user terminal 20 may be set as the desired gathering point, and the current date and time may be set as the desired boarding date and time.

When this information about the desired boarding point, desired gathering point, desired boarding date and time, and desired alighting point is transmitted to the server 30, the server 30 selects, as candidates for the stop positions of buses 40, points around the desired boarding point and points around the desired alighting point where the buses 40 can stop at the desired boarding date and time, and transmits the positions of these points thus selected to the user terminal 20. In addition, the server 30 selects, as candidates for the gathering point, points around the desired gathering point where guidance devices 10 can stop, and transmits the positions of the points thus selected to the user terminal 20. At this time, only the stop points corresponding to the buses 40 that can be reserved and only the gathering points corresponding to the guidance devices 10 that can be dispatched may be transmitted.

Then, the bus use unit 201 causes the display 25 to display a map, so that a boarding point and a slighting point at which the bus 40 can stop and a gathering point at which the guidance device 10 can stop are displayed on the map. In cases where there are a plurality of boarding and alighting points at which the bus 40 can stop or a plurality of gathering points at which the guidance device 10 can stop, these plurality of points should be displayed. The user selects a boarding point, an alighting point, and a gathering point by tapping appropriate points displayed on the display 25 at which the bus 40 can stop and an appropriate gathering point where the guidance device 10 can stop.

When the boarding point, the alighting point, and the gathering point are selected, the bus use unit 201 generates a use request including the user ID, the boarding point, the gathering point, the boarding date and time, the alighting point, the number of persons, and the disability information, and transmits it to the server 30. Thereafter, for example, when information indicating that the reservation has been completed is transmitted from the server 30, the bus use unit 201 displays a screen indicating that the reservation has been completed on the display 25. Here, note that the reservation method is not limited to this, and other methods can also be adopted.

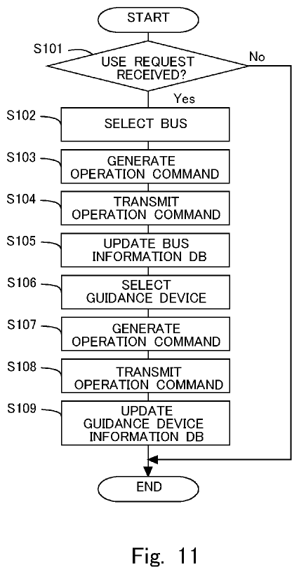

Next, processing of generating operation commands for the guidance device 10 and the bus 40 at the server 30 will be described. FIG. 11 is a flowchart of processing for generating operation commands for the guidance device 10 and the bus 40 at the server 30 according to the present embodiment. The processing illustrated in FIG. 11 is executed at predetermined time intervals at the server 30.

In step S101, the bus management part 301 determines whether or not a use request has been received from a user terminal 20. When an affirmative determination is made in step S101, the processing or routine proceeds to step S102, whereas when a negative determination is made, this routine is ended. In step S102, the bus management part 301 selects a bus 40 on which the user will ride. The bus management part 301 selects the bus 40 based on the information included in the use request and the bus information stored in the bus information DB 312. To be specific, the bus 40 is selected which is capable of moving to a boarding point on a boarding date and time, and then to an alighting point, and which has vacant seats for the number of passengers. After selecting the bus 40, the bus management part 301 may transmit a notification indicating the completion of a reservation for the bus 40 to the user terminal 20.

In step S103, the command part 303 generates an operation command so that the bus 40 departs from the current location and travels via the boarding point and the alighting point on the boarding date and time. In this way, the command part 303 sets the bus stops based on the information about the boarding and alighting points received from the user terminal 20. At this time, a route for the bus 40 may be generated, and it may be included in the operation command. For example, the operation command may cause the display 46 of the bus 40 to show a screen that guides the route of the bus 40.

In step S104, the command part 303 transmits the operation command to the bus 40. Further, in step S105, the command part 303 updates the bus information DB 312. The command part 303 enters the new route in the route field of the corresponding bus 40, and updates fields for the stop point, stop date and time, user ID, and vacant seat, respectively. At this time, if necessary, the records are changed so that the stop points are arranged in the order of stops on the route of the bus 40.

In step S106, the command part 303 selects a guidance device 10 to be dispatched to a gathering point accepted in the use request. The command part 303 selects the guidance device 10 based on the guidance device information stored in the guidance device information DB 313, for example. Specifically, the guidance device 10 is selected which is capable of moving to the gathering point accepted in the use request. The command part 303 selects the guidance device 10 that can arrive at the gathering point a predetermined time before the boarding date and time, for example, taking into account the travel time of the guidance device 10 from the gathering point to the newly added boarding point. At this time, the guidance device 10 is selected based on the route, stop point, and stop date and time stored in the guidance device information DB 313. For example, the guidance device 10 may be selected on the condition that the gathering point exists within a predetermined distance from the current route of the guidance device 10. The predetermined distance may be determined, for example, based on cost.

Here, note that the command part 303 may re-generate the routes of a plurality of guidance devices 10 such that, for example, the total travel distance of the plurality of guidance devices 10 is the shortest. That is, due to the addition of the new gathering point, it is conceivable that the total travel distance as a whole may be shorter if the routes of the plurality of guidance devices 10 are changed than if the route of one guidance device 10 is changed to cope with the new situation. In that case, the routes of the plurality of guidance devices 10 may be changed.

In step S107, the command unit 303 generates an operation command in such a manner that the guidance device 10 will depart from the current location, arrive at the gathering point and perform notification processing, then arrive at the stop point the predetermined time before the stop date and time of the bus 40. The operation command includes a new route of the guidance device 10. In cases where the routes of the plurality of guidance devices 10 are changed, an operation command corresponding to each guidance device 10 is respectively generated.

Then, in step S108, the command part 303 transmits the operation command to the guidance device 10. Further, in step S109, the command part 303 updates the guidance device information DB 313. That is, the new route is entered into the route field of the corresponding guidance device 10, and the stop point, stop date and time, and bus ID are accordingly updated. At this time, if necessary, the records are changed so that the stop points are arranged in the order of stops on the route of the guidance device 10.

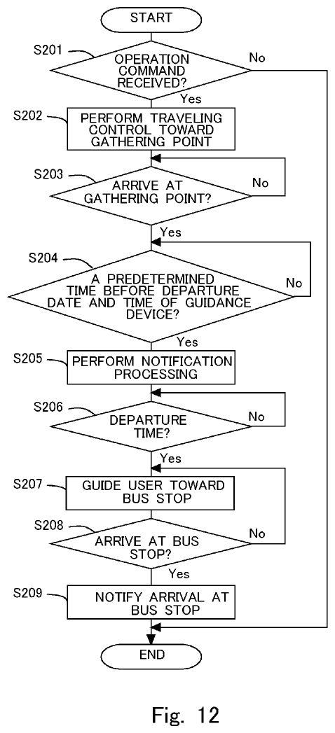

Then, the processing in the guidance device 10 will be described. FIG. 12 is a flowchart of the processing at the time of the operation of the guidance device 10 according to the present embodiment. The processing illustrated in FIG. 12 is executed at predetermined time intervals in the guidance device 10.

In step S201, the traveling unit 101 determines whether or not an operation command has been received. When an affirmative determination is made in step S201, the processing or routine proceeds to step S202, whereas when a negative determination is made, this routine is ended. In step S202, the traveling unit 101 performs traveling control toward the gathering point for users. The traveling unit 101 controls the drive unit 17 so as to move the guidance device 10 to the gathering point for users, for example, based on the current location of the guidance device 10 and the route included in the operation command. Note that a known technique can be used for autonomous traveling by the traveling unit 101.

In step S203, the traveling unit 101 determines whether or not the guidance device 10 has arrived at the gathering point for users. The traveling unit 101 determines whether or not the guidance device 10 has arrived at the gathering point, for example, by comparing the position information obtained by the position information sensor 15 with the information on the gathering point for users included in the operation command obtained from the server 30. When an affirmative determination is made in step S203, the processing proceeds to step S204, whereas when a negative determination is made, the processing of step S203 is performed again.

In step S204, the notification unit 102 determines whether or not it is a predetermined time before the date and time when the guidance device 10 departs from the gathering point. Here, note that in the present embodiment, the notification of information indicating that the guidance device 10 is a guidance device to guide users to the bus stop at which the bus 40 stops, as well as information indicating the departure time to leave for the bus stop, is started the predetermined time before the date and time when the guidance device 10 departs from the gathering point, but instead of this, the notification may be started immediately after the guidance device 10 arrives at the gathering point. When an affirmative determination is made in step S204, the processing proceeds to step S205, whereas when a negative determination is made, the processing of step S204 is performed again.

In step S205, the notification unit 102 performs notification processing. The notification unit 102, for example, displays the screen illustrated in FIG. 9 on the display 18, or transmits, by voice from the speaker 19, information indicating that the guidance device 10 is a guidance device to guide users to the bus stop at which the bus 40 stops and information indicating the departure time at which the guidance device 10 will leave for the bus stop.

In step S206, the traveling unit 101 determines whether or not it is the departure time for the guidance device 10 to depart from the gathering point. The traveling unit 101 may determine whether it is the departure time, for example, based on the departure time at the gathering point included in the operation command and the time indicated by an internal clock of the guidance device 10. When an affirmative determination is made in step S206, the processing proceeds to step S207, whereas when a negative determination is made, the processing of step S206 is performed again.

In step S207, the guidance device 10 guides users from the gathering point to the bus stop. That is, the traveling unit 101 performs traveling control from the gathering point to the bus stop. The traveling unit 101 controls the drive unit 17 so as to move the guidance device 10 to the bus stop, for example, based on the current location of the guidance device 10 and the route included in the operation command. Then, while the guidance device 10 is moving toward the bus stop, the notification unit 102 notifies the users of difficult-to-move points where there are obstacles such as staircases, level differences, or poles installed on the road, etc., existing in the direction of movement of the guidance device 10.

In step S208, the traveling unit 101 determines whether or not the guidance device 10 has arrived at the bus stop. The traveling unit 101 determines whether or not the guidance device 10 has arrived at the bust stop, for example, by comparing the position information obtained by the position information sensor 15 with the information on the bus stop included in the operation command obtained from the server 30. When an affirmative determination is made in step S208, the processing proceeds to step S209, whereas when a negative determination is made, the processing of step S208 is performed again.

In step S209, the notification unit 102 notifies that the guidance device 10 has arrived at the bus stop. For example, the notification unit 102 displays on the display 18 a message indicating that the guidance device 10 has arrived at the bus stop, or outputs, by voice from the speaker 19, the information indicating that the guidance device 10 has arrived at the bus stop. Here, when the guidance device 10 arrives at the bus stop, the traveling unit 101 may perform traveling control toward a base station. The base station is a place where the guidance device 10 is stored and maintained, and is also a place where the guidance device 10 is subjected to charging or the like.

As described above, according to the present embodiment, a guidance device 10 is dispatched to a gathering point where users with disabilities can easily gather. Then, the guidance device 10 thus dispatched guides the users from the gathering point to a stop position of a bus 40 via a route through which the users with disabilities can move relatively safely, so that the users with disabilities can move to the stop position of the bus 40 in a safer manner. In addition, the guidance device 10 notifies the users of the difficult-to-move points existing on the route from the gathering point to the stop position of the bus 40, so that the users can move while paying attention to the difficult-to-move points.

### Second Embodiment

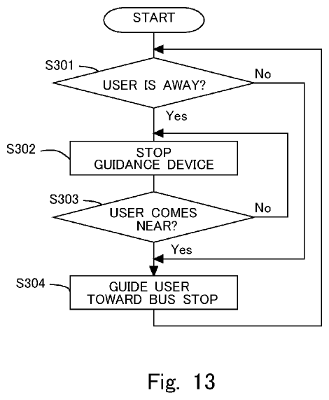

In the first embodiment, a user is guided by a guidance device 10 from a gathering point to a stop position of a bus 40, but in a second embodiment, when the distance between the user and the guidance device 10 becomes equal to or greater than a predetermined distance, the guidance device 10 is stopped until the distance between the user and the guidance device 10 becomes less than the predetermined distance. FIG. 13 is a flowchart of the processing performed in step S207 of FIG. 12. The processing of FIG. 13 is repeatedly performed at predetermined intervals until the guidance device 10 arrives at the bus stop.

In step S301, the traveling unit 101 determines whether or not the distance between the guidance device 10 and the user becomes equal to or greater than the predetermined distance. Measurement of the distance between the guidance device 10 and the user can be made, for example, by using the environmental information sensor 16. For example, the traveling unit 101 may take an image of the user with a stereo camera included in the guidance device 10 as the environmental information sensor 16, thereby measuring the distance between the guidance device 10 and the user based on the image thus taken. When an affirmative determination is made in step S301, the processing proceeds to step S302, whereas when a negative determination is made, the processing proceeds to step S304.

In step S302, the traveling unit 101 stops the guidance device 10. In step S303, the traveling unit 101 determines whether or not the distance between the guidance device 10 and the user becomes less than the predetermined distance. When an affirmative determination is made in step S303, the processing proceeds to step S304, whereas when a negative determination is made, the processing proceeds to step S302, where the guidance device 10 is continuously stopping. Then, in step S304, the traveling unit 101 guides the user toward the bus stop.

According to the second embodiment, in cases where the distance between the guidance device 10 and the user becomes equal to or greater than the predetermined distance, the guidance device 10 can stop and wait for the user. Therefore, according to the second embodiment, it is possible to suppress or prevent only the guidance device 10 from arriving at the stop position of the bus 40 while leaving the user on the route from the gathering point to the stop position of the bus 40.

### Third Embodiment

In the first embodiment, in cases where there are difficult-to-move points where it is difficult for a user with a disability to move on a route that guides the user from the gathering point to the stop position of the bus 40, the user is notified of the difficult-to-move points, but the notification of the difficult-to-move points may be omitted. This is possible because the route from the gathering point to the stop position of the bus 40 is set so as avoid the difficult-to-move points as much as possible by referring to the disability support information DB 315. Here, note that depending on the gathering point and the stop position of the bus 40, the route from the gathering point to the stop position of the bus 40 may include difficult-to-move points. In such a case, the safety of the user moving to the stop position of the bus 40 can be further enhanced by notifying the difficult-to-move points as described in the first embodiment.

### Fourth Embodiment

In cases where a guidance device 10 with a display 18 and a guidance device 10 with a speaker 19 are available, respectively, the command part 303 may select an appropriate guidance device 10 to be dispatched according to the disability of each user. For example, in cases where the disability of a user is a visual impairment (e.g., blindness), the command part 303 may select a guidance device 10 with a speaker 19 so that the user can be guided using a sound that can be audibly confirmed. Also, for example, in cases where the disability of a user is a hearing impairment (e.g., deafness), the command part 303 may select a guidance device 10 with a display 18 so that the user can be guided using characters and/or graphics that can be visually confirmed.

### Other Embodiments

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the guidance device 10 may include a part or all of the functions of the server 30.

For example, the guidance device 10 may be configured so as to voluntarily perform notification processing at a gathering point for users. For example, a program, which is configured to start notification to surroundings upon arrival of the guidance device 10 at a gathering point for users in the case where the guidance device 10 has received the gathering point for users from the server 30, may be stored in the main storage unit 12 of the guidance device 10, wherein this program may be executed by the processor 11 of the guidance device 10 to perform the notification.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to dispatch a guidance device to a gathering point for a disabled person who has made a reservation for the use of a bus, to generate a command to move the dispatched guidance device from the gathering point to a point set as a bus stop for the bus, and to transmit the command thus generated to the guidance device.

2. The information processing apparatus according to claim 1, wherein
the controller identifies, as the gathering point, a location of the disabled person obtained from a mobile terminal carried by the disabled person.

3. The information processing apparatus according to claim 1, wherein
the controller generates a command to move the guidance device from the gathering point to the point set as the bus stop for the bus via a route corresponding to the type of disability of the disabled person.

4. The information processing apparatus according to claim 3, wherein
the controller determines the route by referring to a memory that associates a difficult-to-move point with each type of the disability.

5. The information processing apparatus according to claim 1, wherein
the controller makes the command include causing a speaker included in the guidance device to output a sound announcing that the guidance device is a device to guide the disabled person to the point set as the bus stop for the bus, in cases where the type of disability of the disabled person is a visual impairment.

6. The information processing apparatus according to claim 1, wherein
the controller makes the command include causing a display included in the guidance device to output a text announcing that the guidance device is a device to guide the disabled person to the point set as the bus stop for the bus, in cases where the type of disability of the disabled person is a hearing impairment.

7. The information processing apparatus according to claim 1, wherein
the controller makes the command include causing the guidance device to stop until a distance between the disabled person and the guidance device becomes less than a predetermined distance, in cases where the distance between the disabled person and the guidance device becomes equal to or greater than the predetermined distance.

8. The information processing apparatus according to claim 1, wherein
the controller makes the command include causing the guidance device to notify the disabled person of a difficult-to-move point, in cases where there is the difficult-to-move point where it is difficult for the disabled person to move on a route from the gathering point to the point set as the bus stop for the bus.

9. The information processing apparatus according to claim 1, wherein
the controller makes the command include notifying that the bus has arrived at the point set as the bus stop for the bus, when the guidance device arrives at the point set as the bus stop for the bus.

10. An information processing method comprising: dispatching, by a computer, a guidance device to a gathering point for a disabled person who has made a reservation for the use of a bus; generating a command to move the dispatched guidance device from the gathering point to a point set as a bus stop for the bus; and transmitting the command thus generated to the guidance device.

11. The information processing method according to claim 10, further comprising:
identifying, by the computer, as the gathering point, a location of the disabled person obtained from a mobile terminal carried by the disabled person.

12. The information processing method according to claim 10, further comprising:
generating, by the computer, a command to move the guidance device from the gathering point to the point set as the bus stop for the bus via a route corresponding to the type of disability of the disabled person.

13. The information processing method according to claim 12, further comprising:
determining, by the computer, the route by referring to a memory that associates a difficult-to-move point with each type of the disability.

14. The information processing method according to claim 10, further comprising:
making, by the computer, the command include causing a speaker included in the guidance device to output a sound announcing that the guidance device is a device to guide the disabled person to the point set as the bus stop for the bus, in cases where the type of disability of the disabled person is a visual impairment.

15. The information processing method according to claim 10, further comprising:
making, by the computer, the command include causing a display included in the guidance device to output a text announcing that the guidance device is a device to guide the disabled person to the point set as the bus stop for the bus, in cases where the type of disability of the disabled person is a hearing impairment.

16. The information processing method according to claim 10, further comprising:
making, by the computer, the command include causing the guidance device to stop until a distance between the disabled person and the guidance device becomes less than a predetermined distance, in cases where the distance between the disabled person and the guidance device becomes equal to or greater than the predetermined distance.

17. The information processing method according to claim 10, further comprising:
making, by the computer, the command include causing the guidance device to notify the disabled person of a difficult-to-move point, in cases where there is the difficult-to-move point where it is difficult for the disabled person to move on a route from the gathering point to the point set as the bus stop for the bus.

18. The information processing method according to claim 10, further comprising:
making, by the computer, the command include notifying that the bus has arrived at the point set as the bus stop for the bus, when the guidance device arrives at the point set as the bus stop for the bus.

19. A moving object which is to be dispatched to a gathering point for a disabled person who has made a reservation for the use of a bus, the moving object being configured to move from the gathering point to a point set as a bus stop for the bus via a route corresponding to the type of disability of the disabled person.

20. The moving object according to claim 19, wherein
the moving object stops until a distance to the disabled person becomes less than a predetermined distance, in cases where the distance to the disabled person becomes equal to or greater than the predetermined distance.
